(19) United States
(12) Patent Application Publication
(10) Pub. No.: US 2021/0309455 A1
(43) Pub. Date: Oct. 7, 2021

(54) BOWL AND LID FOR FOOD PREPARATION AND DISPOSAL

(71) Applicant: David L. Cook, Chelan, WA (US)

(72) Inventor: David L. Cook, Chelan, WA (US)

(21) Appl. No.: 16/840,367

(22) Filed: Apr. 4, 2020

(51) Int. Cl. B65F 1/16; B65D 43/02

(52) U.S. Cl. CPC B65F 1/16; B65D 65/466; B65D 2543/00833; B65D 43/0222

(57) ABSTRACT

A container suitable for receiving, storing and disposing of food scraps and waste comprises a bowl with matching lid. The lid, embodiments of which are planar, has two tabs that may be bent perpendicularly to engage corresponding slots in the bowl. The bowl has an annular expansion to receive and further retain the circumference of the lid. Embodiments fashion the tabs so that, when the lid is in place with the tabs protruding through the slots in the bowl, the tabs may be further bent upright around the rim of the bowl, further to secure the lid and retain material within the container.

### BACKGROUND OF THE INVENTION

### Field of the Invention

This invention relates to containers for food and food waste. More specifically, this invention relates to such containers with lids, both of which are compostable or biodegradable.

### Description of the Related Art

The preparation of food often generates considerable scraps and waste material. There is a need to receive and retain such material during food preparation along with a need for temporary storage and disposal of food waste subsequent to food preparation. Because food waste is often or even usually biodegradable, ecological disposal of food waste is often possible and accordingly a container for food waste that is also biodegradable is desirable.

A bowl is an article applicable to receive food waste. Many kitchens utilize general purpose cooking bowls or repurposed pre-packaged food containers for the temporary reception and storage of waste. Further, to retain the waste material for more than a short period, a lid may be provided for the container to seal in the waste material, with varied degrees of efficacy.

An exemplary general purpose bowl with lid that may be used for receiving and storing food waste is described in U.S. Pat. No. 4,341,324 A to Ramirez, which discloses a bowl and cover assembly. Ramirez's bowl and cover are formed of flexible foamed plastic. An annular skirt on the cover engages with a deformable annular lip on the bowl to form a seal for storing material. A limitation of Ramirez's invention is that the efficacy of the sealing between cover and bowl depends on the specific flexibility of the component material in relation to critical thicknesses of the cover skirt and bowl lip elements, demanding exacting fabrication requirements specific to the materials used. A further limitation is that even with ideal fabrication, the Ramirez bowl's cover may not be held sufficiently firmly so that the bowl's contents are still retained when the bowl is other than in a stable upright position. Finally, Ramirez's bowl is fashioned of foamed plastic material that may not be suitable for environmentally sound disposal.

Lidded bowls that have served as containers for pre-packaged food may be adaptable for use in food preparation. For example, U.S. Pat. No. 9,708,106 B2 to Vovan discloses a tamper-evident bowl with a lid that closes on the bowl, the lid having a tear-tab or barrier that indicates whether the lid has been opened after the bowl was originally packaged with food. Embodiments have a pull-open section that must be torn or removed in order to lift the lid and open the container. After the originally packaged food has been consumed, Vovan's bowl may be used to receive and retain food waste and Vovan's lid may be used to seal and retain the waste material. However, after its initial opening as a container of pre-packaged food, Vovan's bowl and lid suffer the same limitation as those of Ramirez: the lid is not sufficiently secured to the bowl to seal contents when the bowl is other than in an upright position. Further, Vovan requires that his bowl be formed of sheet plastic which again may not be suitable for ecological disposal.

In their design patent, U.S. D550,041 S for a disposable serving bowl and lid, Rush et al. appear to address the problem of securing the lid to the bowl by fabricating a lid with three tabs that engage in corresponding slots in their bowl. While addressing this issue, the Rush lid is of a fairly complex design not easily suitable for fabrication with compostable materials. Further, the difficulty of inserting the three tabs of the Rush lid into the three slots in the bowl may frustrate ease of use.

Many containers of pre-packaged food are shipped with lids of a retort grade material that is not suitable for firmly resealing the container when it is repurposed to hold food waste. Exemplary of such containers are those described by Rabinovich et al. in respect to a feeding bowl in U.S. patent application number 20090041910 A1, and by Dalea et al. in U.S. Pat. No. 5,425,474 A, regarding a container holding a stack of covered bowls, each bowl filled with pre-packaged food. Further, such containers are generally not comprised of environmentally friendly material.

What is needed is a container for holding food waste and scraps that has a lid that can be secured to retain material in the container regardless of container orientation. What is needed further is such a container with an arrangement that facilitates ease of use in securing the lid. Further, what is needed is a container and lid combination that is compostable and preferably biodegradable. In addition, it is desired that such a combination be simple in design and easily fabricated.

### SUMMARY OF THE INVENTION

A container suitable for receiving, storing and disposing of food scraps and waste comprises a bowl with matching lid. The easily fabricated lid, embodiments of which are planar, has two tabs that may be bent perpendicularly to engage corresponding slots in the bowl. The bowl has an annular expansion to receive and further retain the circumference of the lid. Embodiments fashion the tabs so that, when the lid is in place with the tabs protruding through the slots in the bowl, the tabs may be further bent upright around the rim of the bowl, further to secure the lid and retain material within the container. The simple design of both bowl and lid permits fabrication with a wide range of biodegradable material.

### BRIEF DESCRIPTION OF THE DRAWINGS

Objects of the present invention as well as advantages, features and characteristics, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a side view of an embodiment of the bowl of the invention;

FIG. 2 is a top view of an embodiment of the lid of the invention;

FIG. 3 is a perspective view of the bowl in an embodiment of the invention, indicating the bowl's slots with dotted lines;

FIG. 4 is a perspective view of an embodiment of the invention, showing the lid with tabs bent down directed toward receiving slots in the bowl; and

FIG. 5 shows an embodiment of the invention in which the lid is in place on the bowl, the lid's tabs inserted through the corresponding slots in the bowl, the tabs then bent up around the outside of the lip of the bowl to secure the lid in place.

### DETAILED DESCRIPTION OF THE INVENTION

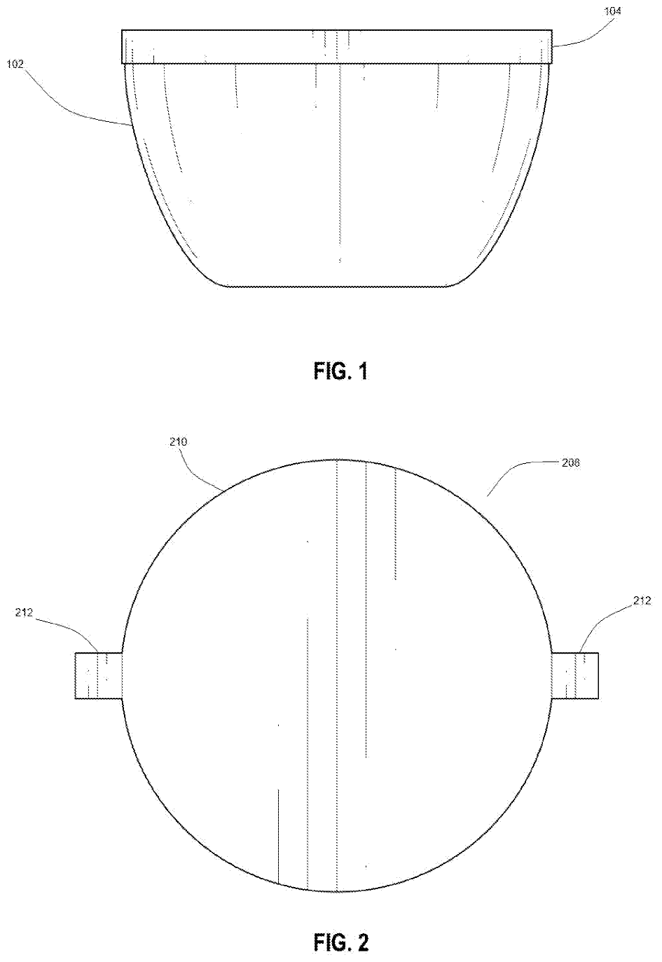

Turning now to the drawings, FIG. 1 depicts a side view of the bowl in an embodiment of the invention. Having a concave shape with truncated flat bottom and open mouth at top, the bowl 102 of the depicted embodiment is of dimensions convenient for everyday kitchen use. A representative embodiment measures 9½ inches in diameter at its top and 5 inches in diameter at its base. Annular expansion 104 is slightly wider than the diameter of the top of bowl 102, measuring 9⅝ inches in diameter and having ⅜ inches in depth in the representative embodiment.

FIG. 2 depicts a top view of an embodiment of the lid of the invention. Lid 208 is a disc 210 of planar material, dimensioned with diameter to match the mouth of its corresponding bowl. In the representative embodiment corresponding to the embodiment discussed in reference to FIG. 1 above, the diameter of disc 210 of lid 208 is 9½ inches. Extending on two opposing sides of disc 210 are tabs 212. In the representative embodiment, tabs 212 are 1 inch in width and two inches in length.

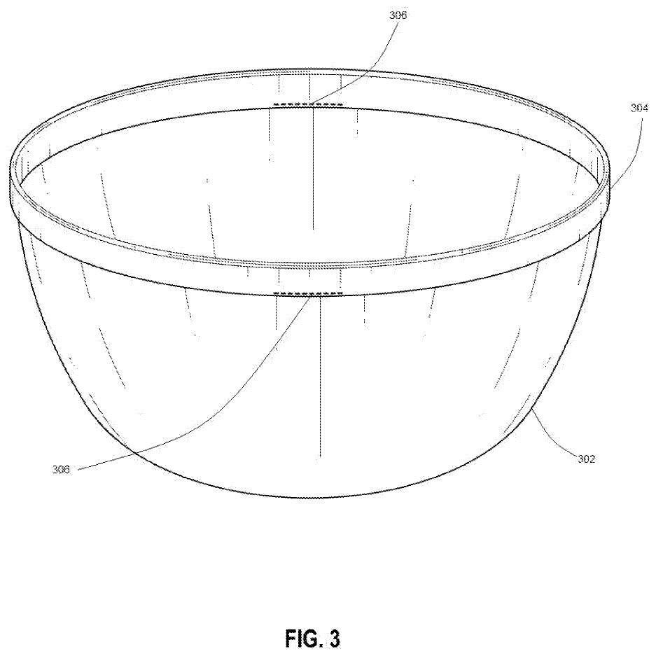

FIG. 3 is a perspective view of the bowl in an embodiment of the invention. Bowl 302 has annular expansion 304 having a diameter slightly larger than the mouth of bowl 302. Within annular expansion 304 are disposed slots 306, indicated by dotted lines. In the exemplary embodiment previously described, slots 306 are 1⅛ inch in width.

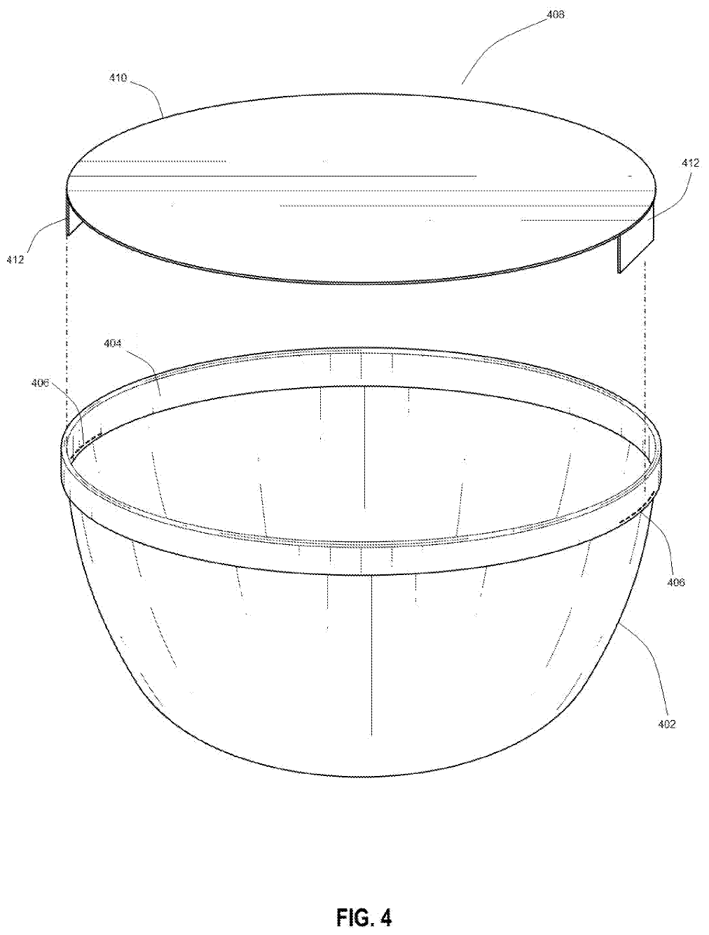

FIG. 4 is a perspective view of an embodiment of the invention. Disc 410 of lid 408 and annular expansion 404 of bowl 402 are dimensioned so that disc 410 of lid 408 fits snugly within annular expansion 404. Tabs 412 of lid 408 are bent downward to be received by appropriately dimensioned slots 406 in annular expansion 404 of bowl 402.

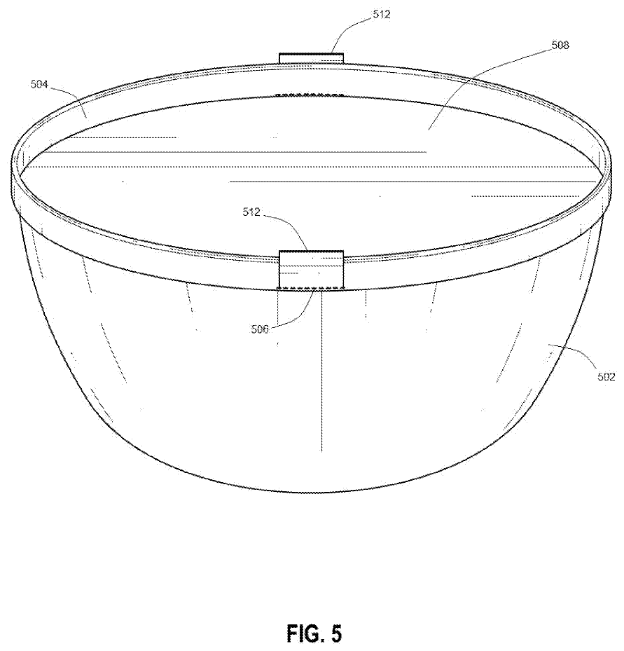

FIG. 5 shows a perspective view of an embodiment of the invention, in which lid 508 is seated within annular expansion 504 of bowl 502. Tabs 512 in lid 508 have been inserted down through slots 506 in bowl 502 and then bent upward around the lip of bowl 502. The tabs 512 inserted in this way and bent upward serve to retain lid 508 securely within annular expansion 504 of bowl 502, regardless of orientation of bowl 502.

In use, the open bowl is dimensioned and designed readily to receive food scraps and waste during food preparation. When the user wishes to store or dispose of the food waste, the user bends the tabs of the lid downward and inserts the tabs into the receiving slots in the annular expansion of the bowl, seating the lid into the annular expansion. The user may then bend the tabs up around the outside of the lip of the bowl, further securing the lid for storage and transport. This process may be reversed if the user desires to reopen the bowl.

In an alternative embodiment, one side of each tab on the lid may be coated with a pressure-sensitive adhesive such as Robond™ 9260 from The Dow Chemical Company of Midland, Mich. In embodiments in which adhesive is on the bottom face of the tabs, after insertion in the slots in the annular expansion the tabs may simply be pressed against the side of the bowl to adhere to and securely hold the lid in place. In embodiments in which adhesive is on the top face of the tabs, when the inserted tabs are folded up, they adhere to the lip of the bowl, thereby securing the lid.

Because of their simple design, the bowl and the lid may be made of a wide range of materials, including in particular compostable materials and preferably biodegradable materials. An embodiment when made of biodegradable material, along with any food waste it contains, may be sealed and disposed of in an ecologically sound manner. The principal limitation for any material for the lid in particular is that it be sufficiently flexible to allow the tabs to fold and engage the slots in the bowl as described herein. Among suitable materials for fabrication are: paper and paper fiberboard; bagasse; biopolymers such as polylactides from corn, soy or potatoes; and bamboo.

Because it is planar in some embodiments, the lid for such embodiments may simply be cut from sheet material. Because the material is foldable, the concave bowl may be formed by folding and gluing an appropriate design cut from the same sheet material. Alternatively, the concave bowl (as well as the lid, if it is not planar) may be formed by compression molding of sheet or pulp material. In any case, though, if glue is used in construction of either the lid or the bowl of the invention, it is preferred that fabrication employ a biodegradable glue, such as a BioTAK® adhesive from BioTAK Sustainable Adhesive Products N.V. of Capelle aan den Ijssel, The Netherlands.

The material composing the lid and/or bowl may further be treated with a coating to provide an air-tight and moisture-proof barrier, thereby more securely to retain food scraps and waste. If a coating is employed, a biodegradable coating, such as bioMERCER® from Fraunhofer-Institut für Silicatforschung ISC of Würzburg, Germany, is preferred to assure full biodegradability and compostability.

The present invention contemplates any applicable methods of industrial fabrication, preferably using biodegradable materials. Persons of skill in the art will readily acknowledge other variations of elements that are still consonant with the teachings of the present invention. For example, while the depicted embodiments show a completely planar lid, other embodiments may instead employ a domed or vaulted lid, so long as it has the two foldable tabs characteristic of the invention engaging with the bowl as set forth above. By way of another example, while the cross-section of the bowl in the embodiments described herein is circular, other embodiments may comprise a convex bowl of another shape, such as one having a square or rectangular cross-section, with a lid of corresponding shape having two tabs that engage via receiving slots in an appropriate expansion section of the bowl.

While the invention has been described with a certain degree of particularity, it should be recognized that elements thereof may be altered by persons skilled in the art without departing from the spirit and scope of the invention. Accordingly, the present invention is not intended to be limited to the specific forms set forth in this specification, but on the contrary, it is intended to cover such alternatives, modifications and equivalents as can be reasonably included within the scope of the invention. The invention is limited only by the following claims and their equivalents.

I claim:

1. A container for food preparation and waste disposal, comprising:
a bowl in combination with a lid,
the bowl comprising:
a convex receptacle having an open mouth, further comprising an annular expansion proximate the mouth, the annular expansion having two slots within it on opposite sides of the mouth; and
the lid fashioned to fit within the annular expansion, the lid having two tabs corresponding to and fashioned to fit within the slots in the annular expansion.

2. The container for food preparation and waste disposal according to claim 1, wherein the lid is planar.

3. The container for food preparation and waste disposal according to claim 1, wherein at least one of the bowl and the lid is comprised of biodegradable material.

4. The container for food preparation and waste disposal according to claim 3, wherein the biodegradable material consists of at least one of paper, biopolymer and bamboo.

5. The container for food preparation and waste disposal according to claim 3, wherein the biodegradable material is coated with a biodegradable coating.
